(19) United States
(12) Patent Application Publication
(10) Pub. No.: US 2005/0272289 A1
(43) Pub. Date: Dec. 8, 2005

(54) Interface card socket

(76) Inventor: Huang-Chou Huang, Taipei (TW)

Correspondence Address: DELLETT AND WALTERS, P. O. BOX 2786, PORTLAND, OR, 97208-2786, US

(21) Appl. No.: 10/860,310

(22) Filed: Jun. 2, 2004

(51) Int. Cl. H01R 13/62

(52) U.S. Cl. 439/153

(57) ABSTRACT

An interface card socket has a body, multiple slots, multiple protruding hooks and multiple notches. The body has a top, a bottom, two sides and a middle. The multiple slots are formed in the middle of the body and open to the top of the body. The multiple protruding hooks are formed integrally with and extend out from one side of the body. The multiple notches are formed respectively in the protruding hooks. The interface card socket will save material, time and expense during manufacturing, and the structure is strong.

### BACKGROUND OF THE INVENTION

1. Field of the Invention

The present invention relates to an interface card socket, and more particularly to an interface card socket that has increased structural strength, is mounted in a motherboard of a computer and into which an interface card plugs.

2. Description of Related Art

To increase the capability of a computer, a computer motherboard has multiple interface card sockets into which various interface cards with different functions plug. A conventional interface card socket has a slot and is mounted on the motherboard. The interface card can plug into the slot to connect to the motherboard. However, holding the interface card on the motherboard only depends on the strength of the interface card socket slot and the structure of conventional interface card sockets is often insufficient to maintain a viable connection over extended use. To solve this problem, Intel Corporation invented a new type interface card, and a new type interface card socket is needed.

With reference to FIGS. 4 and 5, a conventional interface card socket comprises a body (10), multiple slots (12) and multiple protruding hooks (14). The body (10) has two sides (not numbered), a middle (not numbered), a top (not numbered) and a bottom (not numbered). The bottom of the body (10) is mounted on a motherboard of a computer (not shown). The multiple slots (12) are formed in the middle of the body (10) and open to the top of the body (10). The multiple protruding hooks (14) are formed integrally with and extend out from one side of the body (10). An interface card (not shown) can plug into the slots (12) and has a clip (not shown) formed on the interface card that clips onto the protruding hooks (14) of the body (10). The clip will increase the strength of the bond between the interface card and the interface card socket.

However, since the protruding hooks (14) of the body (10) only extend out from one side of the body (10), the two sides of the body (10) are not symmetrical. The interface card socket is manufactured in a mold (not shown) that has two ends (not shown), and the material used to manufacture the interface card socket flows from one end of the interface card socket mold to the other end. Since the material flows at a rate inversely portional to the area filled in the mold, the flow rate of the material on the side corresponding to the protruding hooks (14) is slower than that of the other side. Therefore, a joint seam in the material will be formed in the side with the protruding hooks (14). The joint seam in the side of the interface card socket with the protruding hooks (14) will adversely affect the structural strength of the interface card socket and cause the interface card socket to easily break at the seam.

### SUMMARY OF THE INVENTION

The main objective of the present invention is to provide an interface card socket that has a strong uniform structure and can save material and time when manufacturing the interface card socket.

To achieve the objective, an interface card socket in accordance with the present invention comprises a body, multiple slots, multiple protruding hooks and multiple notches. The body has a top, a bottom, two sides and a middle. The bottom of the body is mounted on a motherboard of a computer. The multiple slots are formed in the middle of the body and open in the top of the body. The multiple protruding hooks are formed integrally with and extend out from one side of the body. The multiple notches are formed respectively in the corresponding protruding hooks. The interface card socket will save material, time and expense during the manufacturing process, and the structure is stronger than the conventional interface card socket.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an interface card socket in accordance with the present invention;

FIG. 2 is a bottom perspective view of the interface card socket in FIG. 1;

FIG. 3 is a cross sectional end view of the interface card socket in FIG. 1;

FIG. 4 is a perspective view of an interface card socket in accordance with the prior art; and

FIG. 5 is a cross sectional end view of the interface card socket in FIG. 4.

### DETAILED DESCRIPTION OF THE INVENTION

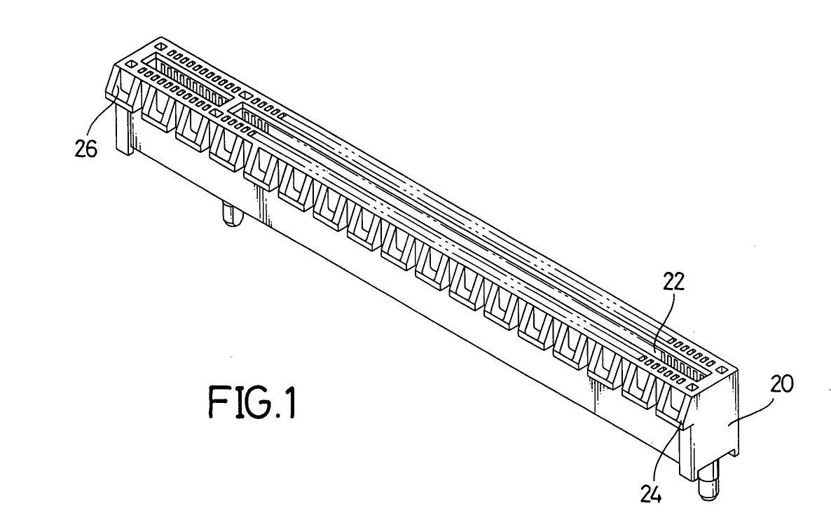

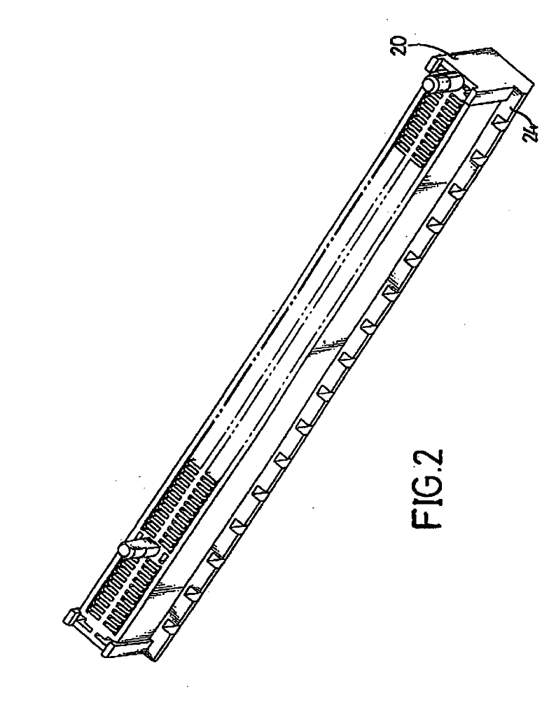

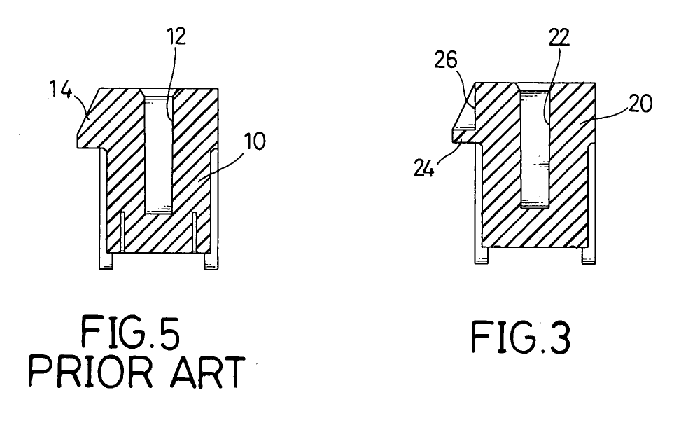

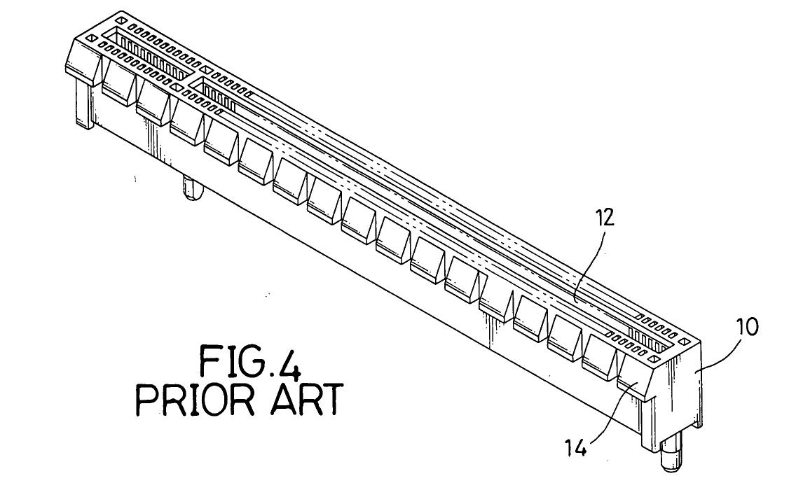

With reference to FIGS. 1 to 3, an interface card socket in accordance with the present invention comprises a body (20), multiple slots (22), multiple protruding hooks (24) and multiple notches (26). The body (20) has a top (not numbered), a bottom (not numbered), two sides (not numbered) and a middle (not numbered). The bottom of the body (20) is mounted on a motherboard of a computer (not shown). The multiple slots (22) are formed in the middle of the body (20) and open to the top of the body (20). The multiple protruding hooks (24) are formed integrally with and extend from one side of the body (20). Preferably, the cross sectional side of the protruding hooks (24) is triangular. The multiple notches (26) are formed respectively in the protruding hooks (24). Preferably, the cross sectional side of the notches (26) is triangular.

Since the interface card socket has a notch (26) in each protruding hook (24), the amount of material needed to manufacture the interface card socket is less than that of the conventional interface card socket. When the material flows in a mold (not shown) with two ends (not shown) to manufacture the interface card socket, the material flows at rates along the two sides, which are almost the same. Furthermore, the mold has an exit formed in one end of the mold to let material that flow a little faster along the side without the protruding hooks (24) to flow out of the mold. Therefore, a joint seam of the material flowing along the two sides will be formed at one end and will not influence the structural strength of the interface card socket.

The interface card socket in accordance with the present invention saves the material, time and expense during manufacturing, and the structure is stronger than the conventional interface card socket.

Although the invention has been explained in relation to its preferred embodiment, many other possible modifications and variations can be made without departing from the spirit and scope of the invention as hereinafter claimed.

1. An interface card socket comprising:
a body having a top, a bottom, two sides and a middle, wherein the bottom of the body is adapted to be mounted on a motherboard of a computer;
multiple slots formed in the middle of the body and opening to the top of the body;
multiple protruding hooks formed integrally with and extending out from one side of the body; and
multiple notches formed respectively in the protruding hooks.

2. The interface card socket as claimed in claim 1, wherein the cross sectional side of the protruding hooks is triangular, and the cross sectional side of the notches is triangular.
